(19) United States
(12) Patent Application Publication
(10) Pub. No.: US 2026/0158410 A1
(43) Pub. Date: Jun. 11, 2026

(54) DISTILLATION HEAT RECYCLING SYSTEMS AND METHODS

(71) Applicant: Frederick Miekka, Arcadia, CA (US)

(72) Inventor: Frederick Miekka, Arcadia, CA (US)

(21) Appl. No.: 19/182,334

(22) Filed: Apr. 17, 2025

Related U.S. Application Data
(60) Provisional application No. 63/635,281, filed on Apr. 17, 2024.

(51) Int. Cl. B01D 3/00; B01D 3/02; B01D 5/00

(52) U.S. Cl. CPC B01D 3/007; B01D 3/02; B01D 5/006

(57) ABSTRACT

A distillation apparatus and method that utilizes the heat of condensation from an initial distillation process to vaporize additional material for distillation. The apparatus may have a condenser that may condenses distillate while transferring the released heat to fresh raw material, and a boiler that may operates at a pressure lower than that of the condenser. The difference in pressure may enable the raw material to boil using the recovered condensation heat, with the resulting vapor being condensed in a secondary condenser to collect additional final distillate. This configuration may increase distillation efficiency by producing a greater quantity of final distillate from the same initial heat input compared to conventional distillation methods.

### PRIORITY CLAIMS AND CROSS-REFERENCE TO RELATED APPLICATIONS

This application is related to and claims domestic priority benefits under 35 USC § 119(e) from U.S. Provisional Patent Application Ser. No. 63/635,281 filed on Apr. 17, 2024, the entire contents, of the aforementioned application, are expressly incorporated hereinto by reference. The entire contents of the aforementioned is hereby incorporated by reference as if fully set forth herein, under 35 U.S.C. § 120. The applicant(s) hereby rescind any disclaimer of claim scope in the parent application(s) or the prosecution history thereof and advise the USPTO that the claims in this application may be broader than any claim in the parent application(s).

### BACKGROUND OF THE INVENTION

### Field of the Invention

This invention is generally concerned with distillation processes and improvements thereto, and more particularly with improvements to the distillation process that make use of the heat generated during the distillation process.

### Background of the Art

Distillation typically involves an apparatus with a distillation column and distillation involves separating each component from a raw material solution containing at least two components. For example, in a raw material containing new components A and B, wherein the boiling point of the component A is lower than that of the component B, the raw material is distilled by heating the raw material in the distillation column so that components A and B are separated.

Accordingly, distillation is a process requires heat and produces heated products, such as components A and B, which may be at elevated temperatures. B would desirable to recover heat from such heated products for release to the distillation process, which would otherwise be wasted as the heated products cool, thus saving energy and increasing efficiency of the distillation process.

Accordingly solutions to the aforementioned problems in the art are needed and desirable.

### SUMMARY

In accordance with an aspect, there is provided an apparatus and the method of distillation that capitalizes on the heat of condensation typically wasted in conventional distillation processes. The invention may have a specialized condenser system that captures and transfers the heat released during condensation of distillate to fresh raw material awaiting distillation. By operating a connected boiler at a pressure lower than that of the primary condenser, the system may enable the transferred heat to effectively vaporize additional raw material. This vapor may be directed to a secondary condenser for collection as additional final distillate. The invention may significantly enhance the distillation efficiency by yielding substantially more distillate from the same initial heat input when compared to traditional distillation techniques.

### ENABLING DESCRIPTION OF THE INVENTION

Systems, apparatus and methods of the invention are directed to solving the problems mentioned above, among others.

Unless otherwise defined, all terms including technical and scientific terms used herein have the same meaning as currently understood by one of ordinary skill in the art to which this invention belongs. It will be further understand that terms, such as those defined in commonly used dictionaries, should be interpreted as having a meaning that is consistent with their meaning in the context of the relevant art and will not be interpreted in an idealized or overly formal sense unless expressly so defined herein.

In this description, various aspects of selected embodiments are described. However, it will be apparent to those of ordinary skill in the art and others that alternate embodiments may b practiced with only some or all of the aspects. For purposes of explanation, specific numbers, materials and configurations may be set forth or left out in order not to obscure the embodiments of the invention while providing a thorough understanding of the embodiments. In addition, in some instances, well-known features are omitted or simplified in order not to obscure the illustrated embodiments. However, it will be apparent to those of ordinary skill in the art and others that alternate embodiments may be practiced without the specific details.

Various operations may be described herein as multiple discreet steps. However, the order of description should blot be construed to imply that these operations are necessarily order dependent. In particular these operations may not be performed in the order of presentation.

Some embodiments of the invention are directed a distillation process in which the feed of initial raw material for distillation in a distillation column first flows through a pipe and is pretreated by one or both of a furnace and/or a heat exchanger, wherein the initial raw material for distillation in the feed pipe is heated in the heat exchanger by head recovered from a product output pip from the distillation column.

In some embodiments, the product output pipe contains initial raw material for distillation vapors of distillation for the distillation column, whereby the latent heat of vaporization is recycled to produce more distillation, such as more distillation of initial raw material for distillations by heating the initial raw material for distillation in the feed pipe.

In some embodiments, the initial raw material for distillation is directed to a second condenser boiler.

In some embodiments, the initial raw material for distillation has a lower boiling material than the martial being distilled in a second condenser boiler.

In some embodiments, there is a higher vacuum created in the second condenser/boiler.

In some embodiments, an inert carrier gas, such as air, or nitrogen is used to carry the initial raw material for distillation vapors.

In some embodiments, a heat pump, coils that heat up, coils that cool off absorb heat from the first condenser and heat is then transferred to boil more liquid in the second stage.

In some embodiments, the process includes a first and second distillation operation, wherein the first distillation is under positive pressure (higher than atmospheric) so the material boils at a higher temperature, thus enabling a greater amount of heat transfer.

In an exemplary embodiment, a feed line is connected with a heat exchanger before being joined to a common pipe line. The common pipe line may extend from the heat exchanger and through a beating furnace before connected at a lower portion of the distillation column.

Water is fed into a high -pressure steam generator and the steam generated flows through a steam supply line. The steam supply line is connected with a steam ejector which in turn is connected with a condenser. The steam ejector has a function of maintaining the vacuum pressure in the distillation column which the condenser has a direction of cooling with a cooling water the steam discharged from the ejector, thereby condensing the steam. The condensed water flows through a discharge pipe.

The overhead vapor flows through an exhaust pipe into a condenser which cools and condenses the overhead product with a cooling water. The gas separated from the overhead product to the condenser flows through the discharge pipe into the ejector. The gas separated in the condenser is connected through an exhaust pipe and the liquid from the condenser flows through the exhaust pipe line into a discharged liquid treating or processing device.

An initial raw material for distillation is fed to the fixed pipe line. All or part of the feed flows through the heat exchanger wherein a distillate product, such as the overhead product, is fed to a pipe and after cooled to some extent by travel through the pipe heats the feed in the feed pipe line to preheat the initial raw material for distillation in the feed pipe.

In some embodiments, the preheated feed may be directed to flow into a second initial raw material for distillation line that feeds in a main feed line and combines preheated initial raw material for distillation with a feed of initial new material for distillations which has not been preheated. Therefore, the combined feed may be further preheated by one or more additional heat exchangers and/or heating furnace. The heating furnace may use steam received under pressure by a steam injector as described above before the feed is discharged in to distillation solution.

One or more distillate streams are withdrawn through separate pipes, from the distillation column. For example, a distillate product may be withdrawn through a pipe into a distillate receiving vessel. The vapors of components may be returned through a pipe to the distillation column or used in a heat exchanger while the distillate product is transported by a pump to a storage tank.

While flowing through the pipe, the distillate product heats and evaporates water for use in the high-pressure steam generator described above; thereby generating or facilitating the generation of he steam and further preheating the feed flowing through the heat exchanger. As a result, the distillate product is cooled before it flows into the storage tank.

A bottom product from the distillation column may be directed to flow through a pipe into the heat exchanger, thus preheating the feed flowing through the feed line 1, which also reduces the temperature of the bottom product. The bottom product may be further directed to facilitate the generation of steam from water flowing in the steam generator, so that the temperature of the bottom product drops further.

In some embodiments, the heat of products from the distillation column is recovered in the form of the steam at high and medium pressures, which may be utilized within the distillation process to preheat initial raw material for distillation in further heat distillate products so that a supply of heat, such as ton the form of steam or through a heating furnace, is unnecessary or reduced, whereby energy is saved and further production of distillate products may be attained. The heat exchange also acts as a coolant resulting in lower temperature products for storage in storage tanks.

In some embodiments, the recycling of heat process is used, with pot stills for batch distillation. The condenser of the pot still can be used to head up more raw material in a second boiler with a liquid that boils with a latent heat of vaporization. This boiling of the liquid in the condenser boiler occurs because the liquid therein is a lower boiling liquid, is getting heat from a heat pump, or is at a lower pressure than the liquid that is at a lower pressure than the liquid that is condensing and giving up it latent heat of vaporization.

In some embodiments, in addition to boiling of raw materials in the condenser boiler, a carrier gas can be used to vaporize liquid that is being heated from the first condenser that is being heated by latent heat of vaporization. This carrier gas vapor can be condensed from the carrier gas stream by cooling it in the second condenser to a lower temperature than the liquid being heated.

The above-described processes allow for a greater amount of first distillate than would otherwise be obtained from the first distillation alone by using the same amount of heat as was used for the first distillation. By using the latent heat of vaporization from the condensing of the vapors of the first distillation to be used to vaporize more material for a second distillation.

As a non-limiting example of how the teachings of this invention can be used, if a fuel additive can be produced by distillation using fermented corn as an initial raw material. The raw material is distilled using a column to produce the azeotropes of ethanol with a few percent water. The water can be removed using molecular sieves (such as zeolite clay). The condensation latent heat of vaporization may then be used to vaporize more raw material that can be condensed and the water removed with molecular sieves. The result is single distilled dehydrated ethanol suitable as a motor fuel additive. A large savings of heat energy results compared with the traditional process. As of 2024, the cost of natural gas is about $14 per Million BTU. Om a typical motor fuel additive ethanol distillery, it takes about 50,000 BTU to produce one gallon of ethanol. Given the natural gas cost of about 75 cents per gallon, by employing the teachings of this invention, just one time, recovering the latent heat of vaporization for another distillation would save about 30 cents per gallon in natural gas costs. That latent heat of vaporization resulting from the condensing vapors from the second distillation may be used to carry out a third distillation, saving even more money in natural gas costs. This savings takes into account the heat losses in the process.

This written description uses examples to disclose the invention and also to enable any person skilled in the art to practice the invention, including making and using any devices or systems and performing any incorporated methods. The patentable scope of the invention may include other examples that occur to those skilled in the art. Other aspects and features of the invention can be obtained from a study of the drawings and the disclosure. The invention may be practiced otherwise than is specifically described herein. It should also be noted that the steps ad the functions listed herein, notwithstanding the order of which steps and/or functions listed, are not limited to any specific order of operation.

While exemplary apparatus, systems and methods of the invention have been described herein, it should also be understand that the foregoing is only illustrative of a few particular embodiments with exemplary and/or preferred features, as well as priciples of the invention, and that various modifications can be made by those skilled in the art without departing from the scope and spirit of the invention. Therefore, the described embodiments should not be considered as limiting the scope of the invention in any way. Accordingly, the invention embraces alternatives, modifications and variations which fall within the spirit and scope of the invention as set forth herein and any equivalents thereto.

What is claimed is:

1. A distillation apparatus and method that uses the heat of condensation of a distillation to vaporize more material for distillation resulting in more final distillate then from the first distillation using the same amount of heat. The apparatus consists of a condenser for condensing distillate to provide heat to fresh initial raw material for distillation along with a boiler that uses the heat to boil raw material at a pressure lower than that of the condenser so that the raw material for distillation will boil from this heat so that it can be condensed in another condenser to collect more final distillate.
